(19) United States
(12) Patent Application Publication
(10) Pub. No.: US 2008/0128407 A1
(43) Pub. Date: Jun. 5, 2008

(54) SHAVING RAZOR DRYER

(76) Inventor: Brian Scott Cohn, Atlanta, GA (US)

Correspondence Address: GARDNER GROFF GREENWALD & VILLANUEVA. PC, 2018 POWERS FERRY ROAD, SUITE 800, ATLANTA, GA, 30339, US

(21) Appl. No.: 11/756,087

(22) Filed: May 31, 2007

Related U.S. Application Data
(63) Continuation of application No. 11/566,392, filed on Dec. 4, 2006.

(51) Int. Cl. H05B 1/02

(52) U.S. Cl. 219/509

(57) ABSTRACT

A razor blade is dried by inserting a razor into a device having an electrically operated fan that turns on when a user places the razor into or onto it. The controller that controls the fan includes at least a suitable switch or sensor and a power source but can also include a timer that turns the fan off after a predetermined time interval.

### CROSS-REFERENCE TO RELATED APPLICATION

This is a continuation-in-part of U.S. patent application Ser. No. 11/566,392, filed Dec. 4, 2006, the benefit of the filing date of which is hereby claimed, and the specification of which is incorporated herein in its entirety by this reference.

### BACKGROUND OF THE INVENTION

1. Field of the Invention

The present invention relates generally to shaving razors and, more specifically, to a device that prolongs the life of a shaving razor by drying it after use.

2. Description of the Related Art

Common everyday razor blades used for shaving the face, legs, and other parts of one's body have become increasingly expensive. They can easily be the most expensive item one puts into their shopping cart. The cost per blade, compared to the usable life of the blade is very high. It is a misconception that razor blades wear out, i.e., become dull, primarily due to the razor cutting through hair stubble. Certainly this is one contributing factor, but what most people do not realize is that the main cause of razor dulling is the effect of water and moisture.

Rinsing and storing the blade in open air, over and over again, causes oxidation (i.e., rusting) and calcification of the blade. The combination of soap, moisture, shaving cream, and indoor air quickly corrode the fine cutting edge of the blade. This usually occurs in under 10 days for most blades on the market. Corrosive deposits can quickly build up on the blade edge. These irregular deposits rapidly alter the cutting edge, creating the dullness effect and causing the user to experience nicks and cuts. In contrast, the act of shaving has a much more gradual effect on blade wear.

It would be desirable to provide a method and device for prolonging razor blade life. The present invention addresses these problems and deficiencies and others in the manner described below.

### SUMMARY OF THE INVENTION

The present invention relates to drying a razor blade in a device having an electrically operated fan that turns on when a user places a shaving razor into (or, in alternative embodiments, onto) it, thereby directing a flow of air toward the blade to dry it. The controller that controls the fan includes at least a suitable switch and a power source (for example, batteries or, alternatively, a wall plug), but can also include additional circuitry, such as a timer that turns the fan off after a predetermined time interval.

The device can have a housing that not only encloses the fan and other elements but also has a receptacle adapted to receive the blade end of the razor. For example, it can have a cup-like or sleeve-like shape, i.e., with an open end into which a user places the blade end of the razor. In an exemplary embodiment of the invention, the cup-like or sleeve-like receptacle is oriented vertically when the device is set up for use on countertop or other horizontal surface. An activator portion of the switch is disposed at the bottom of the receptacle. To use the device in this exemplary embodiment, the user holds the razor in a more or less vertical orientation while inserting the blade end of the razor into the receptacle, until the blade end contacts and depresses the activator portion of the switch, which causes the controller to energize or turn on the fan motor. Once inserted, a portion of the razor rests against or is otherwise retained or supported by a portion of the receptacle, which holds it in position while the fan is on so that the user need not continue to hold the razor. The activator portion of the switch can have a shape adapted for contact with the blade, such as a trough shape in which the blade can rest.

Although in the exemplary embodiment of the invention the switch is mechanically activated (e.g., a pushbutton switch), in other embodiments the switch can be of any other suitable type, including but not limited to an optically activated sensor switch (e.g., employing a photodetector), a magnetic proximity switch that senses the razor or blades, or any other suitable type of switch or sensor.

### BRIEF DESCRIPTION OF THE DRAWINGS

FIG. 1 is a perspective view of a razor dryer in accordance with an exemplary embodiment of the invention.

FIG. 2 is a sectional view of the razor dryer of FIG. 1.

FIG. 3 is a schematic diagram of the fan circuit of the razor dryer in accordance with the exemplary embodiment.

### DETAILED DESCRIPTION OF AN EXEMPLARY EMBODIMENT

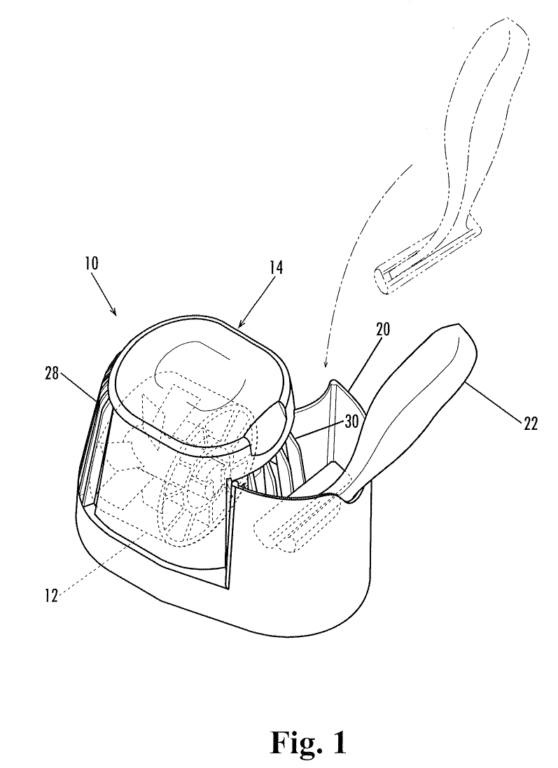

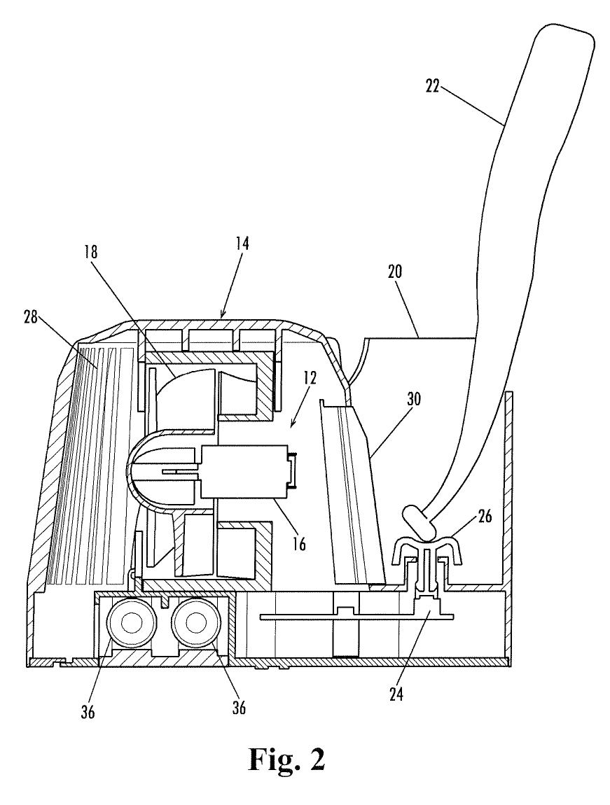

As illustrated in FIGS. 1-2, a razor blade dryer 10 comprises an electrical fan assembly 12 mounted in a housing 14. Fan assembly 12 comprises an electrical motor 16 coupled to a fan blade structure 18. Housing 14 has a receptacle portion 20 with a cup-like or sleeve-like shape for receiving a shaving razor 22. A pushbutton-type (i.e., momentary contact) electrical switch 24 has an activator portion 26 with a trough-like shape disposed at the bottom or distal end of receptacle portion 20. Housing 14 has an air intake grill 28 of louvered openings on one side and a similar air exhaust grill 30 on an opposite side, in receptacle portion 20. Air thus flows horizontally through housing 14, from grill 28 to grill 30, when motor 16 is operating. Although in the exemplary embodiment of the invention housing 14 has a shape generally resembling an inverted cup, in other embodiments the housing can have any other suitable shape. Housing 14 can be made of a suitable corrosion-resistant material such as plastic. Housing 14 can have one or more removable or openable access panels or covers through which various elements can be accessed for purposes of assembly and maintenance (e.g., replacing batteries 36).

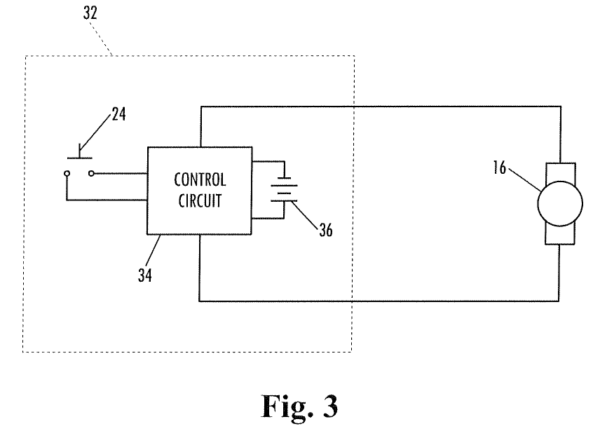

As illustrated in FIG. 3, a controller 32 for controlling blade dryer 10 includes, in addition to switch 24, a control circuit 34 and batteries 36. In the exemplary embodiment, in response to activation of switch 24, control circuit 34 energizes or turns on motor 16. Control circuit 34 can include a timer circuit (not separately shown) so that a predetermined amount of time after turning motor 16 on, it turns motor 16 off again. Control circuit 34 can comprise any suitable type of analog or digital circuitry. In other embodiments, the control circuitry can include any other suitable elements, such as a means for charging rechargeable batteries or using household utility power as a power source instead of batteries.

To use razor blade dryer 10 (e.g., after shaving), a user holds razor 22 in a substantially vertical orientation and inserts it blade-end first into receptacle portion 20 of housing 14 until the blade end contacts activator portion 26. Note that the trough shape of activator portion 26 naturally receives and guides razor 22 as it is reaches the bottom of receptacle portion 20 and provides a convenient support on which the blade end of razor 22 can rest. The elongated shape of receptacle portion 20 also helps receive and guide the shaft of razor 22 as the user inserts it. When the blade end of razor 22 contacts activator portion 26 of switch 24, the force depresses activator portion 26 sufficiently to close or otherwise activate switch 24 at least momentarily. In some embodiments, the weight of the razor can maintain a spring-biased switch in a closed or otherwise activated state. The guiding action of receptacle portion 20 and activator portion 26 ensures activation of switch 24 without the user having to fish around or otherwise exercise much care in positioning razor 22. Rather, the user can essentially simply drop razor 22 into receptacle portion 20. Once razor 22 is inserted in this manner, activator portion 26 supports the blade-end of razor 22, while the shaft of razor 22 rests against the wall of receptacle portion 20. Note that receptacle portion 20 is sufficiently elongated in a direction perpendicular to the air flow axis to support or retain razor 22 in this generally vertical orientation in receptacle portion 20. In other embodiments, the receptacle portion can support or retain the razor in any other suitable manner that holds it in the air flow during drying.

As described above, in response to activation of switch 24, control circuit 34 turns on motor 16, thereby causing fan assembly 12 to blow air into receptacle portion 20 in a direction generally perpendicular to the vertical orientation of razor 22 and directly onto its blade end. The air flow quickly evaporates residual water or moisture on the blades. A few minutes or other predetermined amount of time after turning motor 16 on, the blades are dry, and control circuit 34 turns motor 16 off again, thereby stopping the air flow. As razor 22 has been dried, it will resist corrosion and remain sharp and ready for shaving. The user can choose to leave razor 22 in dryer 10 or, alternatively, remove razor 22 and store it elsewhere.

It is to be understood that the present invention is not limited to the specific devices, methods, conditions, or parameters described and/or shown herein, and that the terminology used herein is for the purpose of describing particular embodiments of the invention by way of example only. For example, unless the context clearly dictates otherwise, as used in the specification and the appended claims, a reference to an element using the singular article “a,” “an,” or “the” encompasses both embodiments having no more than one and embodiments having more than one. The term “or” means “either or both.” Likewise, a reference to an element “on” another element also encompasses embodiments in which one is “in” the other, and conversely, a reference to an element “in” another element also encompasses embodiments in which one is “on” the other. “Coupled” means connected via zero or more intermediate elements. Also, a reference to a particular numerical value includes at least that particular value. In addition, any methods or processes set forth herein are not intended to be limited to the sequence of steps set forth but also encompass other sequences, unless expressly stated otherwise. With regard to the claims, no claim is intended to invoke the sixth paragraph of 35 U.S.C. Section 112 unless it includes the term “means for” followed by a participle.

It will be apparent to those skilled in the art that various modifications and variations can be made to this invention without departing from the spirit or scope of the invention. Thus, it is intended that the present invention cover all modifications and variations of this invention that come within the scope of one or more claims and their equivalents.

What is claimed is:

1. A razor blade dryer, comprising:
a housing having a receptacle adapted to receive a blade end of a shaving razor;
an electrical fan in the housing; and
a controller comprising a source of electrical power and an electrical switch, the electrical switch having an activator portion in the receptacle, the electrical controller electrically coupled to the electrical fan to turn the electrical fan on in response to the blade end of the shaving razor activating the activator portion of the electrical switch when the shaving razor is received in the receptacle.

2. The razor blade dryer claimed in claim 1, wherein the receptacle has a sleeve-like shape for receiving the shaving razor and supporting a portion of the razor therein.

3. The razor blade dryer claimed in claim 2, wherein the fan has a flow axis, and the receptacle is elongated in a direction perpendicular to the flow axis to receive the shaving razor.

4. The razor blade dryer claimed in claim 2, wherein the activator portion of the electrical switch is disposed at a distal end of the receptacle.

5. The razor blade dryer claimed in claim 1, wherein the controller includes a timer for turning off the electrical fan a predetermined time interval after the electrical fan is turned on.

6. A method for drying a razor blade in a device having a housing and an electrical fan, comprising:
placing a blade end of a shaving razor into a receptacle of the housing; and
an electrical controller turning the electrical fan on in response to sensing the shaving razor being received in the receptacle.

7. The method claimed in claim 6, wherein the step of placing the blade end of the shaving razor into the receptacle comprises placing the shaving razor into the receptacle until the blade end activates an activator portion of an electrical switch.

8. The method claimed in claim 7, wherein the receptacle has a sleeve-like shape, and the step of placing the blade end of the shaving razor into the receptacle comprises placing the shaving razor vertically into the receptacle until the blade end contacts an activator portion of the electrical switch disposed at an end of the receptacle.

9. The method claimed in claim 8, wherein the step of the electrical controller turning the electrical fan on comprises the electrical fan blowing air in a horizontal direction toward the blade end.
